(19) United States
(12) Patent Application Publication
(10) Pub. No.: US 2013/0033213 A1
(43) Pub. Date: Feb. 7, 2013

(54) FAN CONTROLLING CIRCUIT FOR SERVER COMPUTER

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., ShenZhen City (CN)

(21) Appl. No.: 13/406,638

(22) Filed: Feb. 28, 2012

(30) Foreign Application Priority Data
Aug. 1, 2011 (CN) 201110217733.7

(51) Int. Cl. H02P 1/04

(52) U.S. Cl. 318/472

(57) ABSTRACT

A circuit for controlling fans of a server computer includes a temperature sensing module configured to sense a temperature inside the server computer and a complex programmable logic device (CPLD) connected to the temperature sensing module. The CPLD includes a pulse width modulation (PWM) module connected to the fans. The PWM module is configured to output a plurality of PWM signals having different duty cycle values to control a rotating speed of each of the fans. The CPLD is configured to determine whether the temperature exceeds a tolerable value.

### BACKGROUND

1. Technical Field

The present disclosure relates to a controlling circuit for fans of a server computer.

2. Description of Related Art

A plurality of fans may be installed in a server computer for dissipating heat in the server computer. However, the plurality of fans sometimes cannot satisfy the need of heat dissipation when a number of the fans is insufficient or rotating speeds of the fans are low. On the other hand, the plurality of fans may consume excessive power and generate high noise when the number of the fans is excessive or rotating speeds of the fans are high.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 illustrates an embodiment of a fan controlling circuit.

FIG. 2 illustrates a detailed circuit of a PWM module of the fan controlling circuit of FIG. 1.

### DETAILED DESCRIPTION

The disclosure is illustrated by way of example and not by way of limitation. In the figures of the accompanying drawings, like references indicate similar elements. It should be noted that references to “an” or “one” embodiment in this disclosure are not necessarily to the same embodiment, and such references mean at least one.

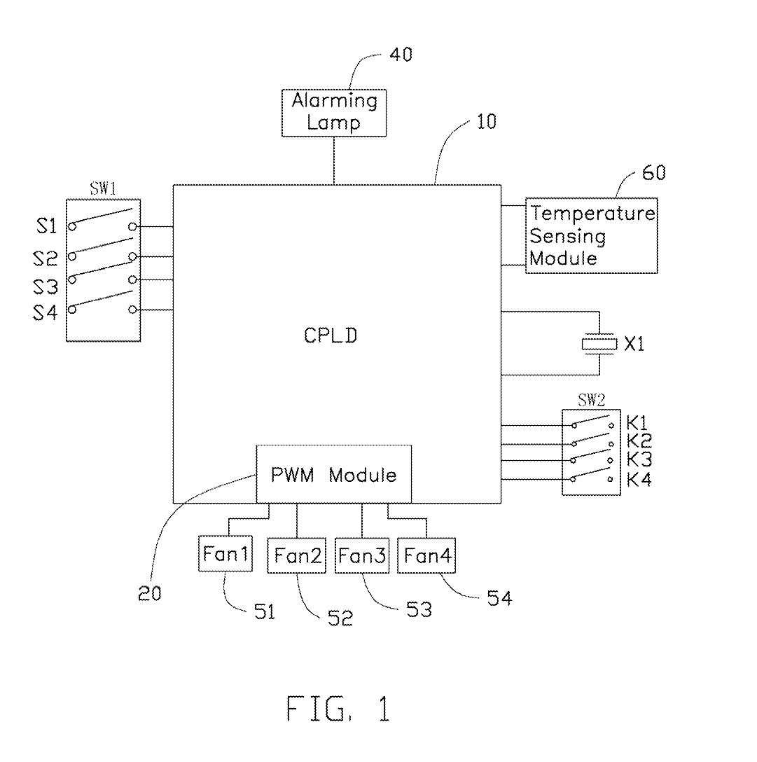

Referring to FIG. 1, an embodiment of a fan controlling circuit includes a complex programmable logic device (CPLD) 10, a first switch module SW1 connected to the CPLD 10, a second switch module SW2 connected to the CPLD 10, a crystal oscillator X1 connected to the CPLD 10, an alarming lamp 40 connected to the CPLD 10, a temperature sensing module 60 connected to the CPLD 10, and a plurality of fans connected to the CPLD 10. The plurality of fans includes a first fan 51, a second fan 52, a third fan 53, and a fourth fan 54. The CPLD 10 includes a pulse width modulation (PWM) module 20. Each of the first fan 51, the second fan 52, the third fan 53, and the fourth fan 54 is connected to the PWM module 20. The PWM module 20 outputs PWM signals to control fan rotating speeds of the first fan 51, the second fan 52, the third fan 53, and the fourth fan 54.

In one embodiment, the first fan 51, the second fan 52, the third fan 53, the fourth fan 54, and the temperature sensing module 60 are installed in a server computer. The temperature sensing module 60 senses a temperature inside the server computer.

The first switch module SW1 includes four switches, S1, S2, S3, and S4. Closed or open states of the switches S1˜S4 determines a duty cycle value of the PWM signal output by the PWM module 20. Assume that each of switches S1˜S4 has a closed state “1” and an open state “0”. A relationship between closed or open states of the switches S1˜S4 and the duty cycle value of the PWM signal is listed in the following table:

| S1 | S2 | S3 | S4 | Duty cycle value |
|---|---|---|---|---|
| 0 | 0 | 0 | 0 | 6.25% |
| 0 | 0 | 0 | 1 | 12.5% |
| 0 | 0 | 1 | 0 | 18.75% |
| 0 | 0 | 1 | 1 | 25% |
| 0 | 1 | 0 | 0 | 31.25% |
| 0 | 1 | 0 | 1 | 37.5% |
| 0 | 1 | 1 | 0 | 43.75% |
| 0 | 1 | 1 | 1 | 50% |
| 1 | 0 | 0 | 0 | 56.25% |
| 1 | 0 | 0 | 1 | 62.5% |
| 1 | 0 | 1 | 0 | 68.75% |
| 1 | 0 | 1 | 1 | 75% |
| 1 | 1 | 0 | 0 | 81.25% |
| 1 | 1 | 0 | 1 | 87.5% |
| 1 | 1 | 1 | 0 | 93.75% |
| 1 | 1 | 1 | 1 | 100% |

The second switch module SW2 includes four switches, K1, K2, K3, and K4, for enabling or disenabling the first fan 51, the second fan 52, the third fan 53, and the fourth fan 54. When the switch K1 is switched on, the first fan 51 is enabled and works under the control of the PWM module 20. When the switch K1 is switched off, the first fan 51 is disenabled and does not work. When the switch K2 is switched on, the second fan 52 is enabled and works under the control of the PWM module 20. When the switch K2 is switched off, the second fan 52 is disenabled and does not work. When the switch K3 is switched on, the third fan 53 is enabled and works under the control of the PWM module 20. When the switch K3 is switched off, the third fan 53 is disenabled and does not work. When the switch K4 is switched on, the fourth fan 54 is enabled and works under the control of the PWM module 20. When the switch K4 is switched off, the fourth fan 54 is disenabled and does not work.

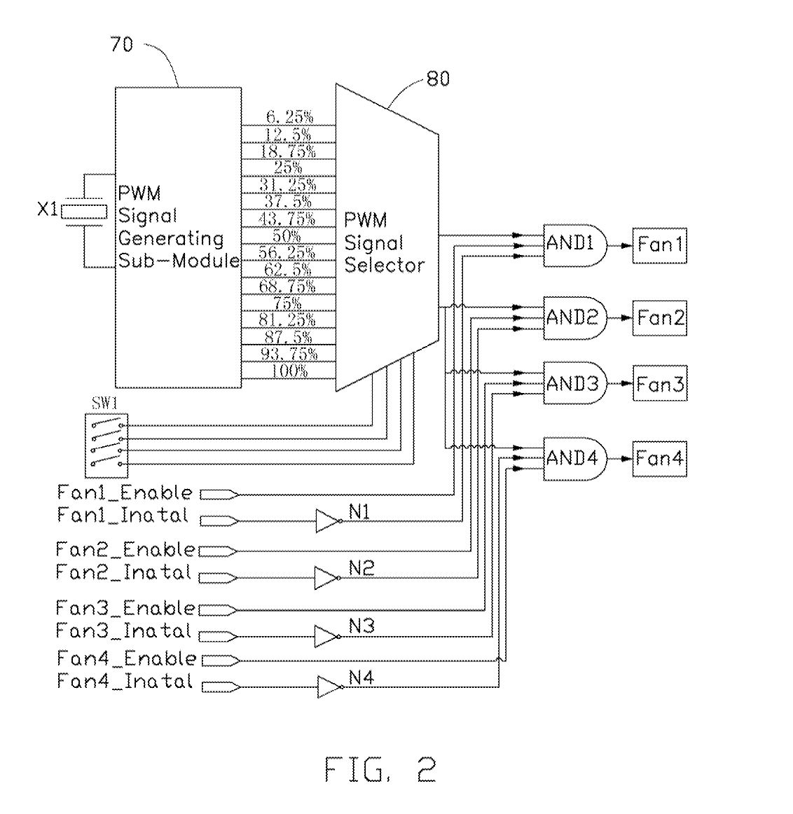

Referring to FIG. 2, the PWM module 20 includes a PWM signal generating sub-module 70, a PWM signal selector 80 connected to the PWM signal generating sub-module 70, a plurality of AND gates AND1˜AND4, and a plurality of inverting gates N1˜N4. The PWM signal generating sub-module 70 includes a plurality of output terminals which output a plurality of PWM signals having duty cycle values of 6.25%, 12.5%, 18.75%, 25%, 31.25%, 37.5%, 43.75%, 50%, 56.25%, 62.5%, 68.75%, 75%, 81.25%, 87.5%, 93.75%, or 100%. The PWM signal selector 80 selects and outputs one of the plurality of PWM signals to the AND gates AND1˜AND4. The first switch module SW1 is connected to the PWM signal selector 80. The PWM signal selector 80 makes the selection according to closed or open states of the switches S1˜S4 of the first switch module SW1 (see above table).

The AND gate AND1 includes three input terminals. A first one of the input terminals is connected to an output terminal of the PWM signal selector 80. A second one of the input terminals is coupled to receive a Fan1_Enable signal of the first fan 51. A third one of the input terminals is connected to an output terminal of the inverting gate N1. An input terminal of the inverting gate N1 is coupled to receive a Fan1_Install signal of the first fan 51. The Fan1_Enable signal is at a logic high level “1” when the switch S1 is switched on to enable the first fan 51, or at a logic low level “0” when the switch S1 is switched off to disenable the first fan 51. The Fan1_Install signal is an active-low level signal. When the first fan 51 is installed in the server computer, the Fan1_Install signal is at the logic low level. When the first fan 51 is plugged off from the server computer, the Fan1_Install signal is at the logic high level. An output terminal of the AND gate AND1 is connected to the first fan 51 and outputs PWM signals to control a rotating speed of the first fan 51.

The AND gate AND2 includes three input terminals. A first one of the input terminals is connected to an output terminal of the PWM signal selector 80. A second one of the input terminals is coupled to receive a Fan2_Enable signal of the second fan 52. A third one of the input terminals is connected to an output terminal of the inverting gate N2. An input terminal of the inverting gate N2 is coupled to receive a Fan2_Install signal of the second fan 52. The Fan2_Enable signal is at the logic high level when the switch S2 is switched on to enable the second fan 52, or at the logic low level when the switch S2 is switched off to disenable the second fan 52. The Fan2_Install signal is an active-low level signal. When the second fan 52 is installed in the server computer, the Fan2_Install signal is at the logic low level. When the second fan 52 is plugged off from the server computer, the Fan2_Install signal is at the logic high level. An output terminal of the AND gate AND2 is connected to the second fan 52 and outputs PWM signals to control a rotating speed of the second fan 52.

The AND gate AND3 includes three input terminals. A first one of the input terminals is connected to an output terminal of the PWM signal selector 80. A second one of the input terminals is coupled to receive a Fan3_Enable signal of the third fan 53. A third one of the input terminals is connected to an output terminal of the inverting gate N3. An input terminal of the inverting gate N3 is coupled to receive a Fan3_Install signal of the third fan 53. The Fan3_Enable signal is at the logic high level when the switch S3 is switched on to enable the third fan 53, or at the logic low level when the switch S3 is switched off to disenable the third fan 53. The Fan3_Install signal is an active-low level signal. When the third fan 53 is installed in the server computer, the Fan3_Install signal is at the logic low level. When the third fan 53 is plugged off from the server computer, the Fan3_Install signal is at the logic high level. An output terminal of the AND gate AND3 is connected to the third fan 53 and outputs PWM signals to control a rotating speed of the third fan 53.

The AND gate AND4 includes three input terminals. A first one of the input terminals is connected to an output terminal of the PWM signal selector 80. A second one of the input terminals is coupled to receive a Fan4_Enable signal of the fourth fan 54. A third one of the input terminals is connected to an output terminal of the inverting gate N4. An input terminal of the inverting gate N4 is coupled to receive a Fan4_Install signal of the fourth fan 54. The Fan4_Enable signal is at the logic high level when the switch S4 is switched on to enable the fourth fan 54, or at the logic low level when the switch S4 is switched off to disenable the fourth fan 54. The Fan4_Install signal is an active-low level signal. When the fourth fan 54 is installed in the server computer, the Fan4_Install signal is at the logic low level. When the fourth fan 54 is plugged off from the server computer, the Fan4_Install signal is at the logic high level. An output terminal of the AND gate AND4 is connected to the fourth fan 54 and outputs PWM signals to control a rotating speed of the fourth fan 54.

To control speeds of the first fan 51, the second fan 52, the third fan 53, and the fourth fan 54, the switches K1˜K4 are switched on. The Fan1_Enable signal, the Fan2_Enable signal, the Fan3_Enable signal, and the Fan4_Enable signal are at the logic high level and sent to the AND gates AND1˜AND4. Since the first fan 51, the second fan 52, the third fan 53, and the fourth fan 54 are already installed in the server computer, the Fan1_Install signal, the Fan2_Install signal, the Fan3_Install signal, and the Fan4_Install signal are at the logic low level. The inverting gates N1˜N4 invert the Fan1_Install signal, the Fan2_Install signal, the Fan3_Install signal, and the Fan4_Install signal and output logic high level signals to the AND gates AND1˜AND4. One or more of the switches S1˜S4 is closed or open to select one of the plurality of PWM signals output from the PWM signal generating sub-module 70. For instance, when the switches S1˜S2 are open and switches S3˜S4 are closed. The PWM signal selector 80 selects and outputs the PWM signal with a duty cycle value of 25% to each of the AND gates AND1˜AND4. Then each of the first fan 51, the second fan 52, the third fan 53, and the fourth fan 54 rotates at 25 percents of its full rotating speed. When the switch S1 is open and switches S2˜S4 are closed. The PWM signal selector 80 selects and outputs the PWM signal with a duty cycle value of 50% to the each of AND gates AND1˜AND4. Then each of the first fan 51, the second fan 52, the third fan 53, and the fourth fan 54 rotates at a half of its full rotating speed. The temperature sensing module 60 senses a temperature inside the server computer. The CPLD 10 determines whether the temperature exceeds a tolerable value. If the temperature exceeds the tolerable value, the alarming lamp 40 is lit up.

In one embodiment, rotating speeds of the first fan 51, the second fan 52, the third fan 53, and the fourth fan 54 can be controlled by the PWM module 20 and decreased gradually. It's useful to determine how to satisfy the need of heat dissipation while power consumption and noise of the fans are kept as low as possible.

While the present disclosure has been illustrated by the description in this embodiment, and while the embodiment has been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A circuit for controlling fans of a server computer comprising:
a temperature sensing module adapted to sense a temperature inside the server computer; and
a complex programmable logic device (CPLD), connected to the temperature sensing module, comprising a pulse width modulation (PWM) module connected to the fans, the PWM module configured to output a plurality of PWM signals; wherein each of the plurality of PWM signals comprises a duty cycle value to control a rotating speed of each of the fans; and the CPLD is configured to determine whether the temperature exceeds a tolerable value.

2. The circuit of claim 1, further comprising a first switch module connected to the CPLD, wherein the first switch module comprises a plurality of first switches, the PWM module is configured to select and output one of the plurality of PWM signals corresponding to either a closed state or an open state of each of the plurality of first switches.

3. The circuit of claim 2, wherein the PWM module comprises a PWM signal generating sub-module configured to output the plurality of PWM signals, and a PWM signal selector connected to the PWM signal generating sub-module; the PWM signal selector is connected to the first switch module and configured to select one of the plurality of PWM signals corresponding to either a closed state or an open state of each of the plurality of first switches.

4. The circuit of claim 3, wherein the PWM module further comprises a plurality of AND gates, each of the plurality of AND gates comprises a first input terminal connected to the PWM signal selector, a second input terminal coupled to receive a fan enable signal that indicates either an enable state or a disenable state of each of the fans, and an output terminal connected to each of the fans.

5. The circuit of claim 4, further comprises a second switch module connected to the CPLD, the second switch module comprises a plurality of second switches configured to enable or disenable the fans.

6. The circuit of claim 5, further comprising a plurality of inverting gates, each of the plurality of AND gates further comprises a third input terminal; wherein each of the plurality of AND gates is coupled to each of the plurality of inverting gates via the third input terminal; each of the plurality of inverting gates is coupled to receive a fan install signal that indicates whether each of the fans is installed in the server computer.

7. The circuit of claim 1, further comprises a crystal oscillator connected to the CPLD, the crystal oscillator is adapted to provide clock signals to the CPLD.

8. The circuit of claim 1, further comprising an alarming lamp connected to the CPLD, the CPLD is configured to light up the alarming lamp when the temperature inside the server computer exceeds the tolerable value.

9. The circuit of claim 1, wherein each of the plurality of PWM signals has the duty cycle of value of 6.25%, 12.5%, 18.75%, 25%, 31.25%, 37.5%, 43.75%, 50%, 56.25%, 62.5%, 68.75%, 75%, 81.25%, 87.5%, 93.75%, or 100%.

10. A circuit for controlling a plurality of fans installed in a server computer comprising:
a temperature sensing module adapted to sense a temperature inside the server computer; and
a complex programmable logic device (CPLD) comprising a pulse width modulation (PWM) module configured to output a plurality of PWM signals, and to select one of the plurality of PWM signals to control a rotating speed of each of the plurality of fans; wherein each of the plurality of PWM signals comprises a duty cycle value different from each other;
wherein the CPLD is connected to the temperature sensing module and configured to determine whether the temperature exceeds a tolerable value, and a difference value between any of the duty cycle value of each of the plurality of PWM signals is N times of 6.25%, N is an integer.

11. The circuit of claim 10, further comprising a first switch module connected to the CPLD, wherein the first switch module comprises a plurality of first switches, the PWM module is configured to select and output one of the plurality of PWM signals corresponding to either a closed state or an open state of each of the plurality of first switches.

12. The circuit of claim 11, wherein the PWM module comprises a PWM signal generating sub-module configured to output the plurality of PWM signals, and a PWM signal selector connected to the PWM signal generating sub-module; the PWM signal selector is connected to the first switch module and configured to select one of the plurality of PWM signals corresponding to either a closed state or an open state of each of the plurality of first switches.

13. The circuit of claim 12, wherein the PWM module further comprises a plurality of AND gates, each of the plurality of AND gates comprises a first input terminal connected to the PWM signal selector, a second input terminal coupled to receive a fan enable signal that indicates either an enable state or a disenable state of each of the plurality of fans, and an output terminal connected to each of the plurality of fans.

14. The circuit of claim 13, further comprises a second switch module connected to the CPLD, the second switch module comprises a plurality of second switches configured to enable or disenable the plurality of fans.

15. The circuit of claim 14, further comprising a plurality of inverting gates, each of the plurality of AND gates further comprises a third input terminal; wherein each of the plurality of AND gates is coupled to each of the plurality of inverting gates via the third input terminal; each of the plurality of inverting gates is coupled to receive a fan install signal that indicates whether each of the plurality of fans is installed in the server computer.

16. The circuit of claim 10, further comprises a crystal oscillator connected to the CPLD, the crystal oscillator is adapted to provide clock signals to the CPLD.

17. The circuit of claim 10, further comprising an alarming lamp connected to the CPLD, the CPLD is configured to light up the alarming lamp when the temperature inside the server computer exceeds the tolerable value.

18. The circuit of claim 10, wherein each of the plurality of PWM signals has the duty cycle value of 6.25%, 12.5%, 18.75%, 25%, 31.25%, 37.5%, 43.75%, 50%, 56.25%, 62.5%, 68.75%, 75%, 81.25%, 87.5%, 93.75%, or 100%.
